(19) United States
(12) Patent Application Publication
(10) Pub. No.: US 2002/0005635 A1
(43) Pub. Date: Jan. 17, 2002

(54) Inflatable occupant protective cushion

(75) Inventor: Bernd Nusshor, Mutlangen (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Occupant Restraint Systems GmbH & Co. KG

(21) Appl. No.: 09/904,414

(22) Filed: Jul. 12, 2001

(30) Foreign Application Priority Data
Jul. 13, 2000 (DE) 200 12 115.4

(51) Int. Cl. B60R 21/22

(52) U.S. Cl. 280/730.2

(57) ABSTRACT

An inflatable occupant protective cushion for use in an upper side area in vehicles beneath a vehicle roof edge comprises at least one inflatable chamber that has a wavy contour along an edge facing away from the roof edge. The chamber when inflated has a volume not exceeding 30 liters, the wavy contour defines a height between a wave crest and a wave trough that amounts to at least 50 mm, and the wavy contour has a number of waves that is less than 10.

### FIELD OF THE INVENTION

The invention relates to an inflatable occupant protective cushion for use in an upper side area in vehicles beneath a vehicle roof edge, comprising at least one inflatable chamber that has a wavy contour along an edge facing away from the roof edge.

### BACKGROUND OF THE INVENTION

The height of the inflatable occupant protective cushion for the upper side area in vehicles as is known in the state of the art varies between 400 mm and 430 mm. This size results from the maximum width of the starting material that can be coated in one processing step, which has been 1720 mm until now. Therefore, in order to have as little waste material as possible, preferably four strips having a width of 430 mm were cut from the coated raw material. Today's coating machinery is also able to coat fabric that is 2000 mm wide in one processing step. This allows protective cushions that have a total height of 500 mm and that consequently ensure better protection for the occupants in case of a collision since a larger surface area of the window is covered. Another reason for the increasing size of protective cushions has to do with new vehicle models such as, for example, vans, which have a much taller structure and thus also require a higher protective cushion. One problem that arises in this context is the larger volume of the protective cushion, for which the current gas generators are no longer adequate.

### BRIEF SUMMARY OF THE INVENTION

The invention provides an inflatable occupant protective cushion for use in an upper side area in vehicles beneath a vehicle roof edge which, in spite of a possibly greater total height, can still be used in conjunction with the current gas generators.

This is achieved by an inflatable occupant protective cushion for use in an upper side area in vehicles beneath a vehicle roof edge having at least one inflatable chamber with a wavy contour along an edge facing away from the roof edge, said chamber when inflated having a volume not exceeding 30 liters. The volume reduction results from the wavy contour defining a height between a wave crest and a wave trough that amounts to at least 50 mm and having a number of waves that is less than 10.

Especially when an occupant protective cushion is unfolded, the fabric is subjected to extreme stress, whereby the stress in the area of the circumferential edge can be especially high. In order to reduce the force peaks on the edge and to distribute them over the entire fabric, the edge that is adjacent to the inside of the inflatable chamber is wave-shaped. With the inflatable occupant protective cushions available so far, the wave height of the wavy contour was only a few millimeters. With the present invention, the wave height, amounting to at least 50 mm, means that, for one thing, the stress on the edge is diminished, and secondly that the volume of the protective cushion is reduced.

According to a particular embodiment, the chamber consists of two textile materials that are coated inside of the chamber and joined to each other along a peripheral edge.

Here, it is especially advantageous for the textile material parts to be cut from a coated strip of textile material having a width of about 2000 mm, and for the cushion having a total height from the roof edge to an edge facing away from the roof edge that amounts to about 500 mm. The greater total height has the advantage that a larger part of the vehicle window is covered by the inflated protective cushion and thus that the risk of injury to the vehicle occupant is reduced in case of a collision.

According to another advantageous embodiment, the total height of the cushion from the roof edge to an edge facing away from it amounts to more than 500 mm. In this manner, it is also possible to ensure sufficient protection in case of a collision, even those involving vehicles with a taller vehicle structure and thus a larger window surface area.

### BRIEF DESCRIPTION OF THE DRAWINGS

Further advantages and features of the invention become apparent from the following description of a preferred embodiment as evident from the single drawing to which reference is made and in which:

FIG. 1 shows a completely unfolded occupant protective cushion.

### DETAILED DESCRIPTION OF THE INVENTION

The drawing shows a completely unfolded occupant protective cushion for the upper side area that extends, for example, from next to the front occupant to next to the rear occupant.

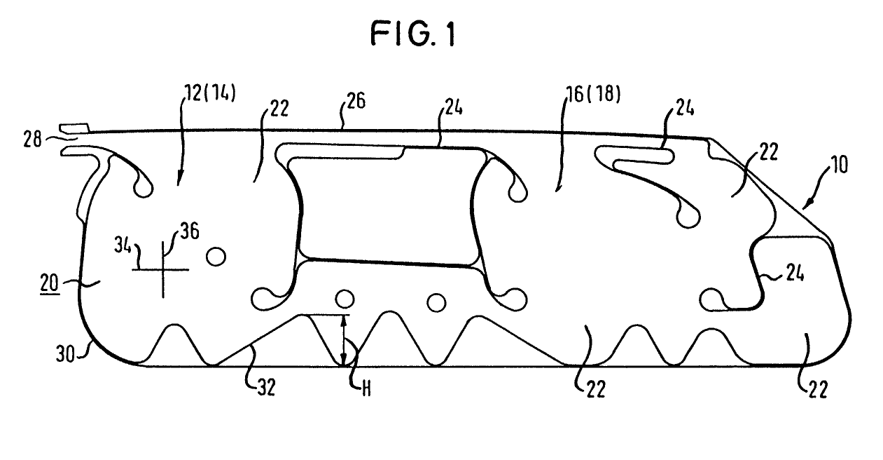

The inflated occupant protective cushion 10 shown in FIG. 1 for the upper side area consists of two opposite walls 12, 14, which are each made of a textile material part 16, 18, of which only the front wall 12 made of the textile material part 16 can be seen, and which form an inflatable chamber 20. The inflatable chamber 20 is divided into several partial chambers 22 which are flow-connected with each other and separated from each other by several partitions 24 formed by sector-wise connection of the two opposite walls 12, 14. A gas lance (not shown here) can be inserted through an opening 28 between an upper circumferential edge 26, which is adapted to the course of the roof frame, and the upper areas of the separating partitions 24, which are essentially parallel to the roof frame. The two textile material parts 16, 18 are coated on their inside and joined to each other at their circumferential edge 30. This connection can be sewn or woven. The edge 30 of the inflatable chamber, which is located across from the roof edge, has a wavy contour 32. The wave height H results from the distance between one wave crest and its adjacent wave valley, and it is at least 50 mm. The number of edge waves here is six.

When a protective cushion is inflated, the textile material parts of the protective cushion are subjected to extra stresses in the area of the lower edge. Due to the wave-shaped contour of the edge, the warp and weft yarns of the textile material parts, which are shown with reference to a yarn 34 and 36 as an example, are subjected to lower stresses than if the edge 32 were to run, for example, parallel to a warp yarn 34. In the latter case, the warp yarn 34 would not be able to absorb any tensile stress and the entire tensile stress would have to be absorbed by the weft yarn 36. The wavy contour in question here has wave heights H which amount to at least 50 mm. As a result, in addition to achieving the stress relief, the volume of the inflatable chamber 20 is also reduced while the total height of the protective cushion 10 remains the same. Consequently, with protective cushions whose total height is more than the current standard height of between 400 mm and 430 mm, it is achieved that their volume does not exceed 30 liters and that they can readily be used with the existing gas generators that are suitable for protective cushions up to a volume of 30 liters.

With the embodiment shown here, the total height of the protective cushion 10 from the roof edge to the side facing away from the roof edge should be about 500 mm. Moreover, due to the wavy contour, conventional gas generators can be used and the greater total height ensures a better protection for the vehicle occupants in case of deployment. Furthermore, this greatly reduces the risk of injury to arms and legs in the lower side area as a result of window surface that is not covered by the protective cushion 10.

The wavy contour 32 of the embodiment shown here is irregular, but according to the invention, a regular wavy pattern would also be possible. Due to the irregular wavy pattern, it is possible to adapt the shape and the inflation behavior of the protective cushion to the vehicle geometry and to the position of the vehicle occupants.

According to an improvement of the invention not shown here, the total height of the protective cushion is more than 500 mm. Protective cushions with such total heights have the advantage that they can be used in vehicles with large window surfaces, for example, vans. The structure and the functioning of such a protective cushion essentially match the embodiment shown in FIG. 1, although the division of the inflatable chamber into partial chambers can be configured somewhat differently.

In case of deployment, gas is fed into the protective cushion 10 via the gas lance (not shown here). The gas flows through outflow openings into the chambers 22 and causes a rapid unfolding of the protective cushion 10 in the downward direction. The protective cushion 10 positions itself firmly in the vehicle at the side of the heads of the front and rear passengers and in front of the side windows, thus protecting the vehicle occupants from injuries.

1. An inflatable occupant protective cushion for use in an upper side area in vehicles beneath a vehicle roof edge, comprising at least one inflatable chamber that has a wavy contour along an edge facing away from the roof edge, said chamber when inflated having a volume not exceeding 30 liters, said wavy contour defining a height between a wave crest and a wave trough that amounts to at least 50 mm, and said wavy contour having a number of waves that is less than 10.

2. The protective cushing according to claim 1, wherein said chamber consists of two textile material parts that are coated inside of the chamber and joined to each other along a peripheral edge.

3. The protective cushion according to claim 2, wherein said textile material parts are cut from a coated strip of textile material having a width of about 2000 mm, and said cushion having a total height from the roof edge to an edge facing away from the roof edge that amounts to about 500 mm.

4. The protective cushion according to claim 1, wherein said cushion has a total height from the roof edge to an edge facing away from the roof edge that amounts to more than 500 mm.

5. The protective cushion of claim 1, wherein the wavy contour has a number of waves that is at least 4.

6. The protective cushion of claim 1, wherein the wavy contour has a number of waves that amounts to 6.
